(19) United States
(12) Patent Application Publication
(10) Pub. No.: US 2019/0006860 A1
(43) Pub. Date: Jan. 3, 2019

(54) Battery Protection Mode

(71) Applicant: Microsoft Technology Licensing, LLC, Redmond, WA (US)

(72) Inventors: Brett Alexander MUZZEY, Seattle, WA (US); Gung Moon CHAN, Seattle, WA (US); Ceceli Ann WILHELMI, Seattle, WA (US); Dawoomi HONG, Kenmore, WA (US); Walter Arthur VAN SCHALKWIJK, Redmond, WA (US); James Shinji NEUMILLER, Redmond, WA (US)

(73) Assignee: Microsoft Technology Licensing, LLC, Redmond, WA (US)

(21) Appl. No.: 15/639,288

(22) Filed: Jun. 30, 2017

(51) Int. Cl. H02J 7/00; G06F 1/32

(52) U.S. Cl. CPC H02J 7/0031; H02J 7/0047; H02J 7/007; H02J 2007/0037; G06F 1/3212; H02J 2007/0049; H02J 2007/005; G06F 1/3287

(57) ABSTRACT

Techniques for a battery protection mode are described. According to techniques described herein, an electronic device can operate in a standard charging mode where a battery of the device is permitted to be charged to full capacity. However, when a trigger event occurs, the electronic device transitions to a battery protection mode where a maximum permitted charge for the battery is reduced from the standard charging mode.

### BACKGROUND

Many devices today utilize some form of battery for various power needs, such as a primary power source, a backup power source, and so forth. Battery life is a primary concern, particularly with mobile devices such as mobile phones, portable computing devices, wearables, and so forth. Devices with batteries that are consistently plugged into alternating current (AC) power are prone to experience battery issues due to sustained 100% charge levels. This is particularly true with lithium-ion batteries.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for a battery protection mode are described. According to techniques described herein, an electronic device can operate in a standard charging mode where a battery of the device is permitted to be charged to full capacity. However, when a trigger event occurs, the electronic device transitions to a battery protection mode where a maximum permitted charge for the battery is reduced from the standard charging mode. In at least one implementation, the trigger event represents a timer that elapses to indicate that the battery has been under external charging power for a threshold period of time. Alternatively or additionally, the trigger event represents state information for a battery, such as received from a fuel gauge that monitors battery state.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Identical numerals followed by different letters in a reference number may refer to difference instances of a particular item.

FIG. 1 is an illustration of an environment in an example implementation that is operable to employ techniques discussed herein.

FIG. 2 is a flow diagram that describes steps in a method for transitioning between a standard charge mode and a battery protection mode.

FIG. 3 is a flow diagram that describes steps in a method for a detailed procedure for transitioning between a standard charge mode and a battery protection mode.

FIG. 4 is a flow diagram that describes steps in a method for prompting a user regarding a battery protection mode.

FIG. 5 is a flow diagram that describes steps in a method for outputting an indication of battery charge level.

FIG. 6 depicts an example mode transition prompt presented in response to an indication to transition between battery charge modes.

FIG. 7 depicts an example indication of battery charge level.

FIG. 8 illustrates an example system and computing device as described with reference to FIG. 1, which are configured to implement implementations of techniques described herein.

### DETAILED DESCRIPTION

Techniques for a battery protection mode are described. According to techniques described herein, an electronic device can operate in a standard charging mode where a battery of the device is permitted to be charged to full capacity. However, when a trigger event occurs, the electronic device transitions to a battery protection mode where a maximum permitted charge for the battery is reduced from the standard charging mode. In at least one implementation, the trigger event represents a timer that elapses to indicate that the battery has been under external charging power for a threshold period of time. Alternatively or additionally, the trigger event represents state information for a battery, such as received from a fuel gauge that monitors battery state.

Generally, the battery protection mode is designed to temporarily reduce the maximum permitted battery charge level, thus allowing a battery to correctly dissipate and avoid expanding due to excessive time spent at full charge level. Thus, techniques described herein protect a battery by enabling increased effective battery life and increased charge capacity over time. Further, techniques also protect devices in which a battery is installed by preventing battery damage that may result in damage to the device itself.

In the following discussion, an example environment is first described that is operable to employ techniques described herein. Following this, several example procedures and implementation details are described in accordance with one or more implementations. Finally, an example system and device are described that are operable to employ techniques discussed herein in accordance with one or more implementations. Consider now an example environment in which example implementations may by employed.

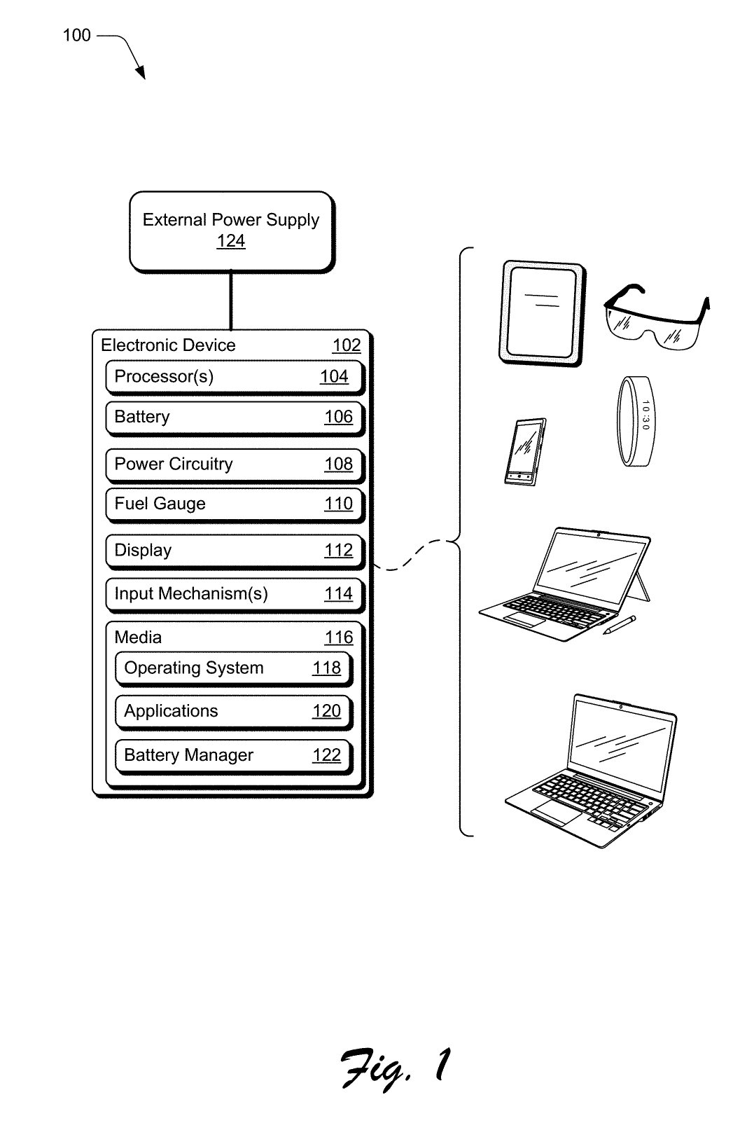

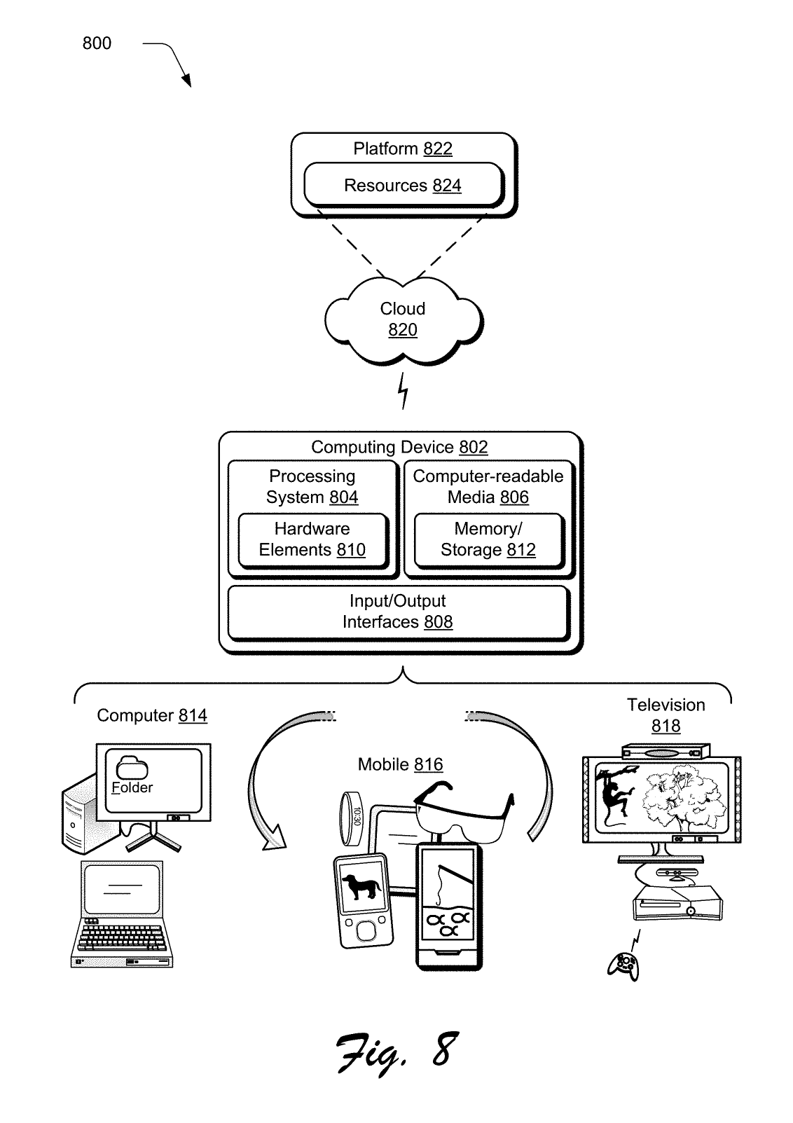

FIG. 1 illustrates an example environment 100 for performing techniques for battery protection mode. Environment 100 includes an electronic device 102, which may be implemented in various ways. The electronic device 102, for instance, may be configured as a traditional computer (e.g., a desktop personal computer, laptop computer, and so on), a mobile station, an entertainment appliance, a wireless phone, a tablet, a netbook, a wearable device, and so forth as further described in relation to FIG. 8.

Thus, the electronic device 102 may range from a full resource device with substantial memory and processor resources (e.g., personal computers, game consoles) to a low-resource device with limited memory and/or processing resources, such as a traditional set-top box, hand-held game console, wearable device, smart appliance (e.g., “Internet of Things” (IoT) device), health monitoring and assistance device, personal navigation device, battery charger, and so forth. The electronic device 102 also relates to software that causes the electronic device 102 to perform various operations. Further, while implementations are discussed herein with reference to a computing device, it is to be appreciated that techniques discussed herein may be utilized in any apparatus that utilizes batteries, such as a medical device, a vehicle (e.g., an electronic vehicle), a robotic machine, a toy, and so forth. The electronic device 102, for instance, may represent an internal controller of an apparatus.

The electronic device 102 includes hardware and functionality that enables the electronic device 102 to operate and perform various tasks, including a processor 104, a battery 106, power circuitry 108, a fuel gauge 110, a display 112, input mechanisms 114, and computer-readable storage media (“media”) 116.

Generally, the processor 104 is representative of functionality to perform data processing and instruction execution for the electronic device 102. Different examples of the processor 104 are discussed below with reference to the system 800 of FIG. 8. The battery 106 represents one or more battery cells from which the electronic device 102 draws power to operate, and which are rechargeable to replenish power within the battery 106. The power circuitry 108 represents functionality to enable the electronic device 102 to draw operating power from the battery 106 or to apply charging power to the battery 106. Although a single battery 106 is illustrated, it is to be appreciated that the battery 106 may include any suitable number or type of battery cells and may be implemented according to a variety of different types and form factors of batteries.

The fuel gauge 110 is representative of functionality to track various operational parameters of the battery 106, such as battery health statistics, battery usage statistics, and so forth. In at least some implementations, information provided by the fuel gauge 110 can be used to determine whether to operate in a battery protection mode. Generally, the fuel gauge 110 can be implemented in various ways, such as hardware (e.g., an integrated circuit (IC)), software, firmware, or combinations thereon.

According to various implementations, the display 112 is representative of functionality for visual output for the electronic device 102, and the input mechanisms are representative of functionality for enabling input to the electronic device 102. Generally, the input mechanisms 114 may be implemented in various ways, and may include gesture-sensitive sensors and devices, such as touch-based sensors and movement-tracking sensors (e.g., camera-based), as well as mice (free-standing or integral with a keyboard), a stylus, touch pads, accelerometers, and microphones with accompanying voice recognition software, to name a few. The input mechanisms 114 may be separate or integral with the display 112, with integral examples including gesture-sensitive displays with integrated touch-sensitive or motion-sensitive sensors.

The media 116 is representative of a data storage component of the electronic device, and stores executable code that can be executed to perform various tasks for the electronic device 102. For instance, the media 116 stores an operating system 118, applications 120, and a battery manager module (“battery manager”) 122.

The operating system 118 manages resources of electronic device 102 and may be implemented using any suitable instruction format. For instance, the operating system 118 generally enables functionalities of the electronic device 102 to access hardware and logic resources of electronic device 102.

The applications 120 include any suitable type of application and/or service, such as productivity applications, web browsers, media viewers, navigation applications, multimedia editing applications, and so forth. According to various implementations, the applications 120 may be implemented as locally-installed code that is executed as part of a local runtime environment. Additionally or alternatively, the applications 120 represent portals to distributed functionality, such as web services, cloud services, distributed enterprise services, and so forth.

The battery manager 122 is representative of functionality to control various operational parameters pertaining to the battery 106. For instance, the battery manager 122 is configured to monitor charge and discharge state of the battery 106, and to transition between different charge modes according to techniques for battery protection mode described herein. Although the battery manager 122 is illustrated separately from the operating system 118, it is to be appreciated that functionality of the battery manager 122 may be implemented in various ways, such as part of the operating system 118, as a component of the battery 106, as a standalone module, and so forth.

The environment 100 further includes an external power supply 124, which is representative of an external power source for the electronic device 102. In at least one implementation, the external power supply 124 is an alternating current (AC) power source to which the electronic device 102 can be connected and disconnected.

The following discussion describes some example procedures for battery protection mode in accordance with one or more implementations. The example procedures may be employed in the environment 100 of FIG. 1, the system 800 of FIG. 8, and/or any other suitable environment. In at least some implementations, the steps described for the various procedures are implemented automatically and independent of user interaction.

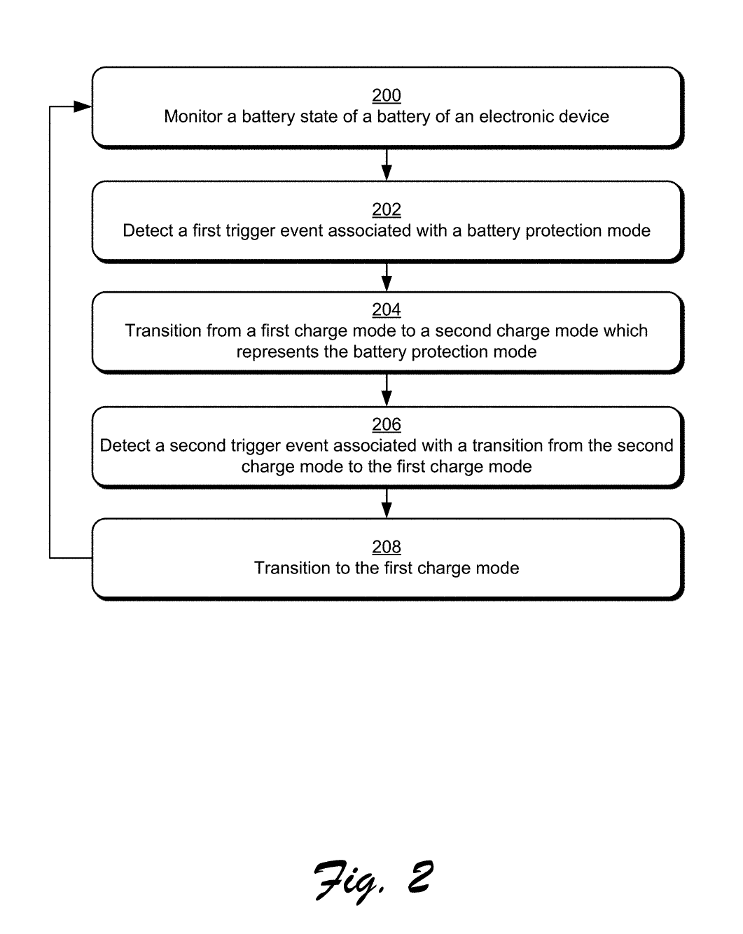

FIG. 2 is a flow diagram that describes steps in a method in accordance with one or more implementations. The method, for instance, describes an example procedure for transitioning between a standard charge mode and a battery protection mode.

Step 200 monitors a battery state of a battery of an electronic device. The battery manager 122, for instance, monitors various state conditions of the battery 106. Examples of such state conditions include a duration of time during which the battery 106 has been under external charging power from the external power supply 124, a state of charge (SOC) of the battery 106, whether the battery 106 is in a battery protection mode, and so forth. In at least some implementations, the battery manager 122 can ascertain battery state information via direct observation of various attributes of the battery 106. Alternatively or additionally, the battery manager 122 can receive battery state information from a separate entity, such as the fuel gauge 110.

While implementations are discussed herein with reference to managing a battery installed in a smart device such as the electronic device 102, the described implementations may be employed to manage battery charge level in a variety of different environments. For instance, the techniques may be employed to manage battery charge level while a battery is connected to a dedicated charging device, such as a standalone battery charger.

Step 202 detects a first trigger event associated with a battery protection mode. The battery manager 122, for example, detects the trigger event via direct observation of the state of the battery 106, and/or via a notification from another entity, such as the fuel gauge 110. In at least one implementation, the trigger event represents an indication that the battery 106 has been under AC charging current and at maximum SOC for a threshold period of time. Generally, maximum SOC refers to a raw SOC value of >98% of total battery charge capacity, and/or >100% or a corrected SOC value. The time threshold can be implemented in various ways, such as in minutes, hours, days, and so forth. In at least one implementation, the time threshold is 7 days. It is to be appreciated, however, that the time threshold may be configured in a variety of different ways within the spirit and scope of the implementations discussed herein. As further discussed below, the trigger event represents an expiration of a timer associated with a battery protection mode.

According to one or more implementations, the trigger event can occur based on information regarding the battery 106 received from the fuel gauge 110, such as remaining full charge capacity dropping below a threshold charge value, cell balancing time exceeding a threshold time, a time at which the battery 106 has spent at full charge exceeding a threshold time, and so forth.

Step 204 transitions from a first charge mode to a second charge mode which represents the battery protection mode. Generally, in the battery protection mode, a maximum permitted charge level for the battery 106 is reduced. For instance, the maximum permitted charge level is reduced from 100% to n %, where n=100%−v, and where v is a specific value such as 15%, 20%, 25%, and so on. Accordingly, in the battery protection mode, the battery will not be charged above n %.

In at least one implementation, a visual prompt can be displayed indicating that the electronic device 102 is transitioning to the battery protection mode. As further detailed below, the prompt may include a selectable indicator that is selectable to allow the transition to the battery protection mode, or that is selectable to prevent the transition to the battery protection mode.

In at least one implementation, a visual indicator of battery charge level of the battery 106 is configured to visually indicate that the battery is at 100% charge, even when in the battery protection mode that battery 106 is only charged to n %.

Step 206 detects a second trigger event associated with a transition from the second charge mode to the first charge mode. In at least one implementation, the second trigger event occurs when the SOC of the battery 106 falls below a threshold charge level, such as 60%, 50%, or any other suitable charge level value. Alternatively or additionally, the second trigger event represents user input instructing the electronic device 102 to exit the battery protection mode. In an example scenario, the second trigger event can occur when the electronic device 102 is removed from external AC power and thus the battery 106 is being discharged to supply power to the electronic device 102.

Step 208 transitions to the first charge mode. The battery manager 122, for instance, causes the electronic device 102 to transition from the battery protection mode to a standard charge mode. In the standard charge mode, the maximum allowed charge level of the battery 106 is increased, such as to 98% raw SOC. Thus, if the electronic device is currently disconnected from an external power source and is subsequently connected to an external power source, the battery 106 will be permitted to be charged to full charge capacity, e.g., 98% raw SOC.

In at least one implementation, the process returns to step 200 where state of the battery 106 is monitored. Thus, if a subsequent trigger event associated with the battery protection mode occurs, the battery manager 122 can cause the electronic device 102 to transition back to the battery protection mode.

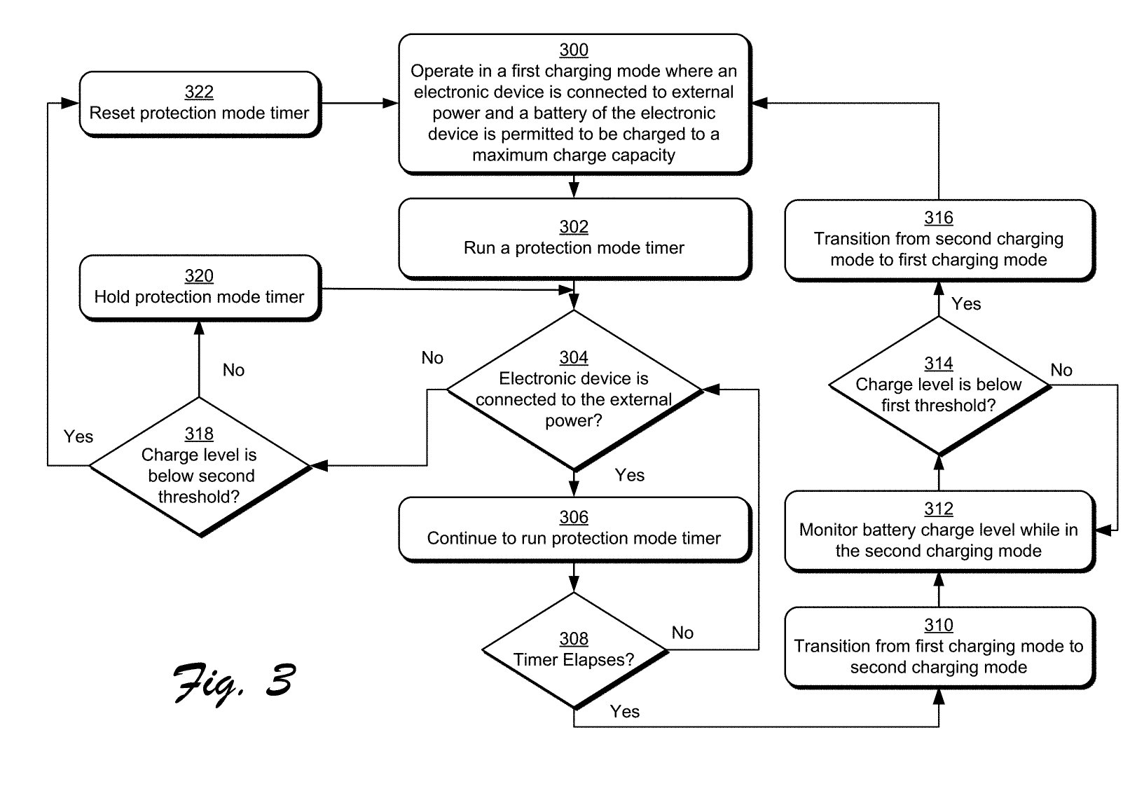

FIG. 3 is a flow diagram that describes steps in a method in accordance with one or more implementations. The method, for instance, describes an example detailed procedure for transitioning between a standard charge mode and a battery protection mode.

Step 300 operates in a first charge mode where an electronic device is connected to external power and a battery of the electronic device is permitted to be charged to a maximum charge capacity. The electronic device 102, for instance, is connected to the external power supply 124, which is used to charge the battery 106. Generally, in the first charge mode, the battery 106 is permitted to be charged to a maximum charge capacity, such as 98% raw SOC and/or 100% corrected SOC.

Step 302 runs a battery protection mode timer. The battery manager 122, for instance, runs a timer that indicates how long the electronic device 102 is connected to the external power and the battery 106 is permitted to be charged to the maximum charge capacity.

Step 304 ascertains whether the electronic device is connected to the external power. The battery manager 122, for example, ascertains whether the electronic device 102 is connected to the external power supply 124.

If the electronic device is connected to the external power supply (“Yes”), step 306 continues to run the protection mode timer. Step 308 determines whether the protection mode timer elapses. The battery manager 122, for example, determines whether the protection mode timer is elapsed. Generally, the protection mode timer can be implemented using a discrete period of time, such as measured in minutes, hours, and/or days.

If the protection mode timer is not elapsed (“No”), the process returns to step 304. If the protection mode timer is elapsed (“Yes”), step 310 transitions from the first charge mode to a second charge mode. Generally, the second charge mode represents a battery protection mode in which a maximum permitted charge level for the battery 106 is reduced as compared to the first charge mode. Example aspects of the battery protection mode are detailed above.

Step 312 monitors battery charge level while in the second charge mode. The battery manager 122, for example, monitors the charge level of the battery 106 while the electronic device 102 is in the battery protection mode.

Step 314 determines whether the battery charge level falls below a first threshold battery charge level. Generally, the first threshold is associated with battery charge level while the electronic device 102 is in the battery protection mode. The first threshold battery charge level, for instance, represents a percentage of total battery charge capacity, such as 60%, 50%, or any other suitable battery charge level.

If the battery charge level does not fall below the first threshold battery charge level (“No”), the process returns to step 312 where the battery charge level is monitored while in the second charge mode, i.e., the battery protection mode.

If the battery charge level falls below the first threshold battery charge level (“Yes”), step 316 transitions from the second charge mode to the first charge mode. As part of this transition, the maximum permitted battery charge level is increased, such as to 100% corrected SOC. The battery charge level may fall below the first threshold battery charge level for various reasons, such as a user removing the electronic device 102 from external power or a failure of an external power source.

In at least one implementation, the process returns to step 300 such that the electronic device operates in the first charge mode and the protection mode timer is restarted.

Returning to step 304, if the electronic device is not connected to the external power supply (“No”), step 318 determines whether the charge level of the battery falls below a second threshold charge level. In at least some implementations, the second threshold charge level is higher than the first threshold charge level. If the charge level does not fall below the second threshold charge level (“No”), step 320 holds the protection mode timer. The protection mode timer, for instance, is paused and does not elapse while the electronic device 102 is disconnected from the external power supply 124 and the charge level of the battery 106 is above the second threshold charge level. In at least some implementations, this prevents a temporary disconnection from the external power supply 124 from causing the battery protection mode timer from resetting. The process returns to step 304 such that connectivity to the external power supply 124 is monitored. If the electronic device 102 is reconnected to the external power supply 124 before the charge level of the battery 106 falls below the second threshold charge level, the process will continue to step 306 where the protection mode timer is restarted from a point at which it was paused at step 320.

Returning to step 318, if the charge level falls below the second threshold charge level (“Yes”), step 322 resets the protection mode timer. The protection mode timer, for instance, is reset to a starting point. The process then returns to step 300 where the electronic device 102 operates in the first charging mode and the protection mode timer begins elapsing from an initial timer start point.

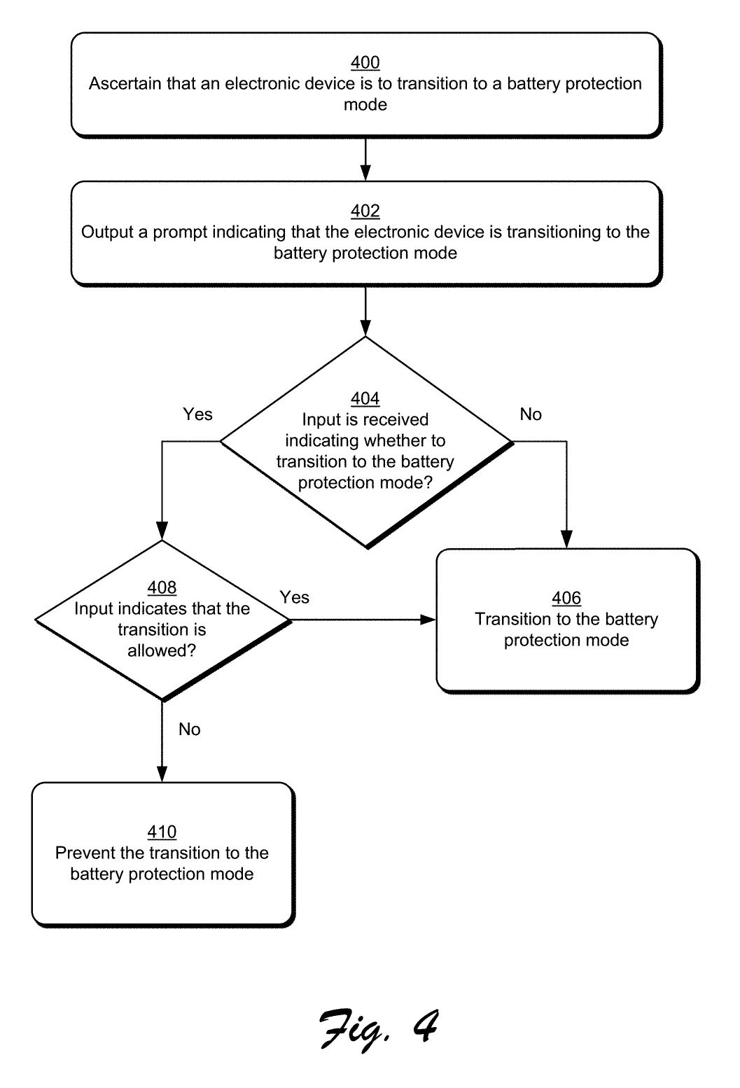

FIG. 4 is a flow diagram that describes steps in a method in accordance with one or more implementations. The method, for instance, describes an example procedure for prompting a user regarding a battery protection mode.

Step 400 ascertains that an electronic device is to transition to a battery protection mode. Different events and conditions that can cause a transition to a battery protection mode are described above.

Step 402 outputs a prompt indicating that the electronic device is transitioning to the battery protection mode. In at least one implementation, the prompt is a visual notification that indicates that the electronic device 102 is transitioning to the battery protection mode. The prompt may include various information pertaining to the battery protection mode, such as that the battery protection mode is intended to prolong the effective life of the battery 106, and/or that the battery protection mode will reduce the maximum permitted charge level for the battery 106.

The prompt may also include selectable indicia that are selectable to allow the transition to the battery protection mode, or to disallow (e.g., prevent) the transition. Additionally or alternatively to a visual prompt, an audible prompt may be presented, such as a voice prompt indicating that a transition to the battery protection mode will occur.

Step 404 determines whether input is received indicating whether to transition to the battery protection mode. The battery manager 122, for instance, determines whether input is received based on the prompt. If input is not received (“No”), step 406 transitions to the battery protection mode. For example, the battery manager 122 transitions from a standard charge mode to a battery protection mode for the battery 106. In at least some implementations, the transition occurs after a period of time has elapsed after presentation of the prompt, such as after x seconds. Generally, x seconds may be implemented in various ways, such as 5 seconds, 10 seconds, or 30 seconds after the prompt is presented. The period of time, however, may be configured in a variety of different ways.

If input is received indicating whether to transition to the battery protection mode (“Yes”), step 408 determines whether the input indicates that the transition is allowed. The battery manager 122, for example, determines whether input to the prompt and/or voice input indicates that the transition is allowed, or that the transition is not allowed. If the input indicates that the transition is allowed (“Yes”), step 406 transitions to the battery protection mode. If the input indicates that the transition is not allowed (“No”), step 410 prevents the transition to the battery protection mode. For instance, the battery manager 122 does not cause the electronic device 102 to transition from a standard charge mode to the battery protection mode. In at least one implementation, when input is received indicating that the transition is not allowed, a battery protection mode timer is reset. Alternatively, a timer that is shorter in duration than the battery protection mode timer can be triggered. After the shorter timer is elapsed, a transition to the battery protection mode can again be initiated. The process, for instance, returns to step 400.

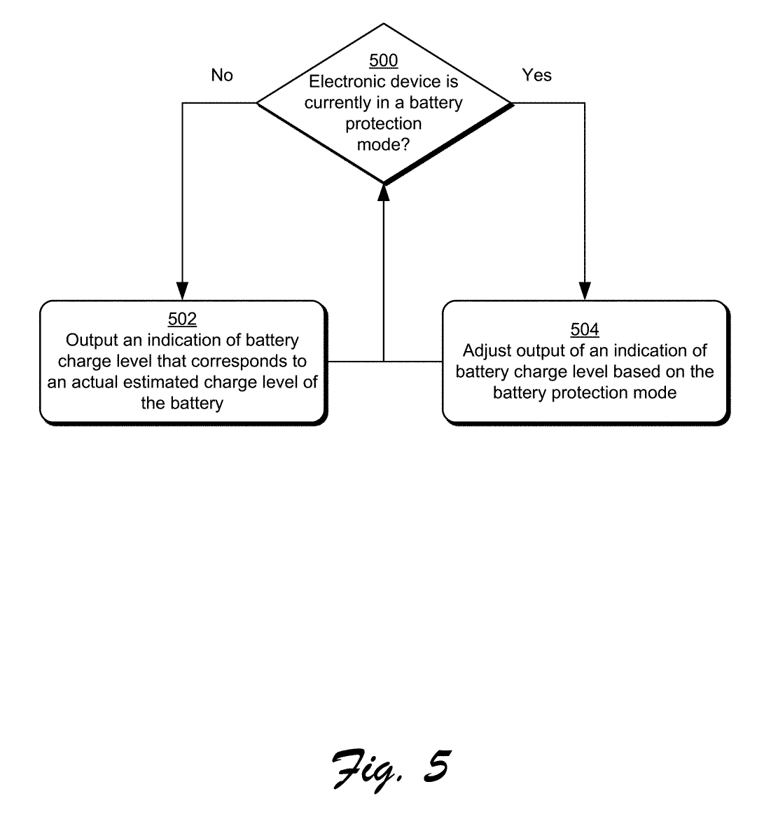

FIG. 5 is a flow diagram that describes steps in a method in accordance with one or more implementations. The method, for instance, describes an example procedure for outputting an indication of battery charge level.

Step 500 ascertains whether an electronic device is currently in a battery protection mode for a battery of the electronic device. The battery manager 122, for instance, determines whether the electronic device 102 is currently in the battery protection mode for charging the battery 106. If the electronic device is not in the battery protection mode (“No”), step 502 outputs an indication of battery charge level that corresponds to an actual estimated charge level of the battery. For example, the battery manager 122 outputs in indication of battery charge level for the battery 106 that corresponds to an actual estimated SOC for the battery 106. An indication of battery charge level can be configured in various ways, such as a visual battery icon that is dynamically configurable based on battery charge level and battery charge mode. Alternatively or additionally, the indication of battery charge level can be configured in other ways, such as an audible sound indicating battery charge level, or a haptic indication of battery charge level.

If the electronic device is in the battery protection mode (“Yes”), step 504 adjusts output of an indication of battery charge level based on the battery protection mode. In the battery protection mode, for instance, an indication of battery charge level does not always reflect the actual estimated SOC of the battery 106. For example, consider that in the battery protection mode, the maximum permitted battery charge level is n %, such as described above. Accordingly, when the SOC of the battery 106 is n % in the battery protection mode, the indication of battery charge level is configured to indicate that the battery 106 is at 100% SOC. Thus, even though the actual SOC of the battery 106 is less than 100%, the indication of battery charge level is configured to indicate that the battery 106 is at 100% charge level.

Consider further that when in the battery protection mode, the SOC of the battery 106 falls below n % but stays above a threshold value, such as c %, where c is a value such as 60% or any other suitable value. In this particular battery charge range where n %>SOC>c %, the indication of battery charge level can be adjusted as a fraction of the actual estimated SOC of the battery 106. For instance, the indication of battery charge level can be configured to indicate that the battery charge level of the battery 106 is SOC/x, where x is a value such as 0.75. If, however, the SOC of the battery 106 falls below c %, the electronic device 102 will exit the battery protection mode and the indication of battery charge level will be configured to reflect the actual estimated SOC of the battery 106.

Thus, an indication of battery charge level (e.g., a battery icon) can be dynamically configured and reconfigured based on whether a battery is being charged in a battery protection mode or a standard charge mode, and based on SOC while the battery is being charged in the battery protection mode.

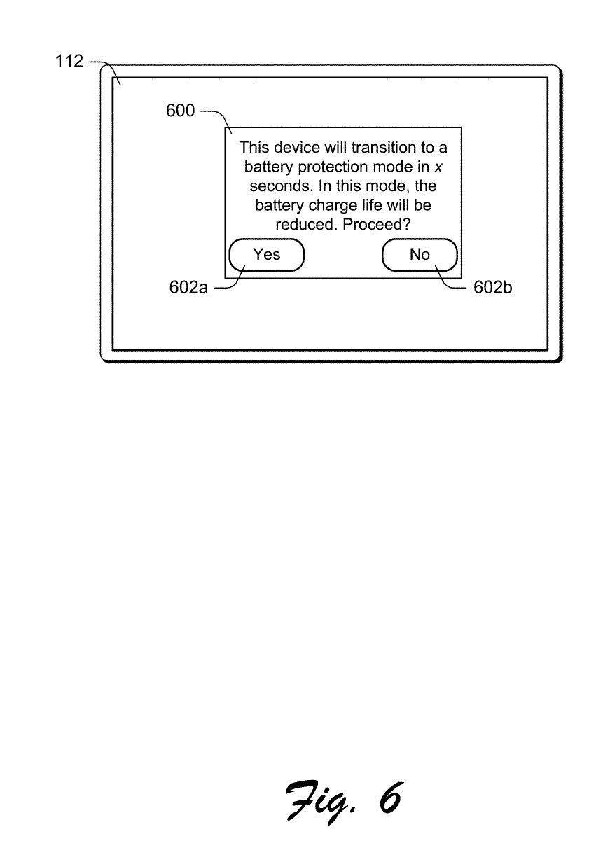

FIG. 6 depicts an example mode transition prompt 600 in accordance with one or more implementations. The prompt 600, for instance, is displayed on the display 112 of the electronic device 102 in response to a trigger event indicating that a transition to a battery protection mode is to occur. The prompt 600 includes text that indicates that the transition will occur in x seconds. The prompt 600 also indicates that in the battery protection mode, a charge life of the battery 106 will be reduced. This notifies a user that if they disconnect the electronic device 102 from the external power supply 124 while in the battery protection mode, the actual available charge level of the battery 106 will be less than a full battery charge.

The prompt 600 also includes a selectable control 602a and a selectable control 602b. The selectable control 602a is selectable to cause the transition to the battery protection mode to proceed. For instance, selection of the selectable control 602a causes the battery manager 122 to transition to a battery protection mode. The selectable control 602b is selectable to prevent the transition to the battery protection mode. Selection of the selectable control 602b, for instance, causes the electronic device 102 to remain in a standard charge mode. In at least one implementation, selecting the selectable control 602b causes a protection mode timer to be reset, or a shorter duration timer to be triggered after which a transition to the battery protection mode can be initiated.

Generally, when the prompt 600 is presented and x seconds elapses without input to either of the selectable controls 602a, 602b, an automatic transition to the battery protection mode occurs and the prompt 600 is automatically removed.

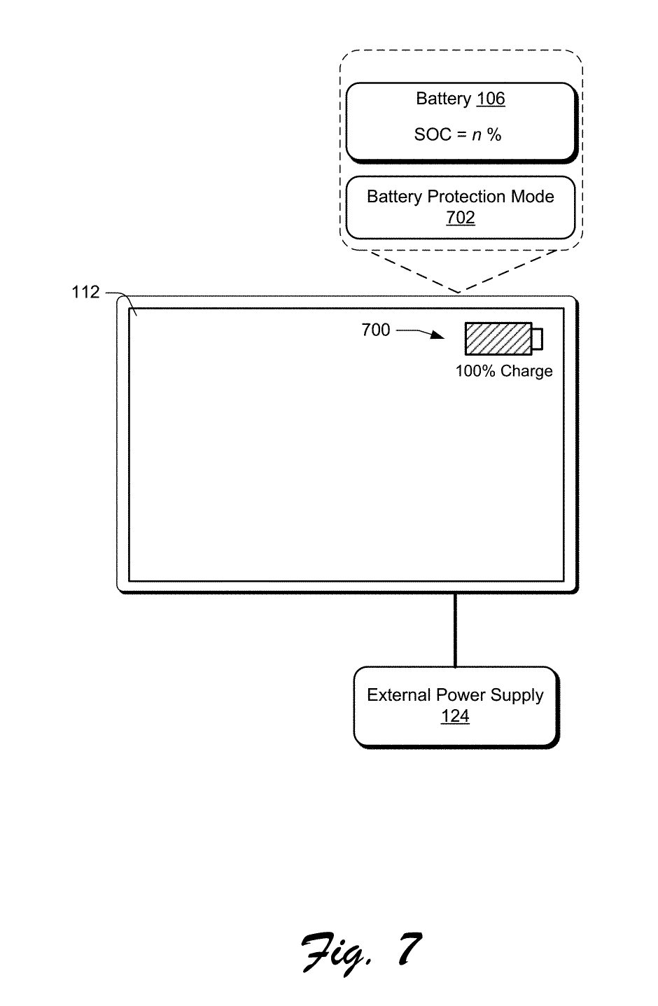

FIG. 7 depicts an example indication of battery charge level (“charge indication”) 700 in accordance with one or more implementations. Generally, the indication 700 is displayed on the display 112. In this particular example, the indication 700 is displayed while the electronic device 102 is connected to the external power supply 124 and in a battery protection mode 702. Further, the SOC of the battery 106 is n %, which as discussed above is a maximum permitted charge level in the battery protection mode, but is less than a full charge capacity of the battery 106.

As shown, the charge indication 700 visually represents that the battery 106 is charged to its full charge capacity of 100% charge, even though the actual SOC of the battery 106 is n %. Thus, the charge indication 700 may not reflect that the maximum permitted charge level of the battery 106 is reduced in the battery protection mode 702. Generally, this avoids a situation where a user may think there is a charge problem with the battery 106 if the charge indication 700 indicates that a charge level of the battery 106 is reduced while the electronic device 102 is connected to the external power supply 124.

As discussed above, if the electronic device 102 transitions out of the battery protection mode 702, such as in response to being removed from the external power supply 124, the charge indicator 700 can be reconfigured to reflect an actual estimated SOC of the battery 106.

Accordingly, techniques described herein provide ways for protecting effective life of a battery, such as by preventing damage to a battery that may occur when the battery is charged to full capacity over an extended period of time. Further, the techniques do not require user input to enter a battery protection mode, but may leverage automated events such as expiration of a timer and/or information retrieved from a fuel gauge that monitors battery state.

Having discussed some example procedures, consider now a discussion of an example system and device in accordance with one or more implementations.

FIG. 8 illustrates an example system generally at 800 that includes an example computing device 802 that is representative of one or more computing systems and/or devices that may implement various techniques described herein. For example, the electronic device 102 can be embodied as the computing device 802. The computing device 802 may be, for example, a server of a service provider, a device associated with the client (e.g., a client device), an on-chip system, and/or any other suitable computing device or computing system.

The example computing device 802 as illustrated includes a processing system 804, one or more computer-readable media 806, and one or more Input/Output (I/O) Interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 810 and computer-readable media 806 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of modules that are executable by the computing device 802 as software may be achieved at least partially in hardware, e.g., through use of computer-readable storage media and/or hardware elements 810 of the processing system. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, a multi-screen computer, laptop computer, netbook, and so on.

The computing device 802 may also be implemented as the mobile 816 class of device that includes mobile devices, such as a mobile phone, portable music player, portable gaming device, a tablet computer, a wearable device, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. For example, functionalities discussed with reference to the battery manager 122 may be implemented all or in part through use of a distributed system, such as over a “cloud” 820 via a platform 822 as described below.

The cloud 820 includes and/or is representative of a platform 822 for resources 824. The platform 822 abstracts underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device embodiment, implementation of functionality described herein may be distributed throughout the system 800. For example, the functionality may be implemented in part on the computing device 802 as well as via the platform 822 that abstracts the functionality of the cloud 820.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

In the discussions herein, various different implementations are described. It is to be appreciated and understood that each implementation described herein can be used on its own or in connection with one or more other implementations described herein. Further aspects of the techniques discussed herein relate to one or more of the following implementations.

A system for enabling a battery protection mode, the system including: at least one processor; and one or more computer-readable storage media including instructions stored thereon that, responsive to execution by the at least one processor, cause the system perform operations including: detecting a trigger event associated with a battery protection mode for a battery of an electronic device, the trigger event representing one or more of an expiration of a timer or information received from a fuel gauge that monitors state of the battery; and transitioning from a first charge mode to a second charge mode which represents the battery protection mode, the battery protection mode having a reduced maximum permitted charge level for the battery as compared to the first charge mode.

In addition to any of the above described systems, any one or combination of: wherein the timer is configured to elapse in response to the electronic device being connected to an external power supply and the electronic device being in the first charge mode; wherein the timer is configured to elapse in response to the electronic device being connected to an external power supply and the electronic device being in the first charge mode, and wherein the operations further include, prior to said detecting the trigger event: determining that the electronic device is disconnected from the external power supply and that a charge level of the battery is above a threshold charge level; holding the timer while the electronic device is disconnected from the external power supply and the charge level of the battery is above the threshold charge level; wherein the timer is configured to elapse in response to the electronic device being connected to an external power supply and the electronic device being in the first charge mode, and wherein the operations further include, prior to said detecting the trigger event: determining that the electronic device is disconnected from the external power supply and that a charge level of the battery is above a threshold charge level; holding the timer while the electronic device is disconnected from the external power supply and the charge level of the battery is above the threshold charge level; ascertaining that the electronic device is reconnected to the external power supply; and resuming the timer in response to the electronic device being reconnected to the external power supply; wherein the information received from the fuel gauge includes one or more of an indication that a remaining full charge capacity of the battery drops below a threshold charge value, an indication that a cell balancing time for the battery exceeds a threshold cell balancing time, or an indication that a time at which the battery has spent at full charge exceeds a full charge threshold time; wherein said transitioning from the first charge mode to the second charge mode occurs automatically in response to the trigger event and independent of user input; wherein the operations further include presenting a prompt indicating that a transition from the first charge mode to the second charge mode will occur, the prompt including a first selectable control which is selectable to permit the transition to the second charge mode, and a second selectable control which is selectable to prevent the transition to the second charge mode; wherein in the second charge mode the charge level of the battery is below a maximum charge capacity of the battery, and wherein the operations further include: adjusting an indication of battery charge level for the battery based on the battery protection mode to indicate that the battery is at the maximum charge capacity while the battery is charged below the maximum charge capacity; wherein in the second charge mode the charge level of the battery is below a maximum charge capacity of the battery, and wherein the operations further include: adjusting an indication of battery charge level for the battery based on the battery protection mode to indicate that the battery is at the maximum charge capacity while the battery is charged below the maximum charge capacity; ascertaining that the electronic device is transitioned from the second charge mode to the first charge mode; and outputting the indication of battery charge level to correspond to an actual estimated charge level of the battery; wherein the operations further include: ascertaining that a battery charge level of the battery falls below a threshold charge level while the electronic device is in the second charge mode; and transitioning from the second charge mode to the first charge mode in response to said ascertaining that the battery charge level falls below the threshold charge level, the first charge mode having a higher permitted maximum charge level as compared to the second charge mode.

A computer-implemented method for transitioning between battery charge modes, the method including: detecting a trigger event associated with a battery protection mode for a battery of an electronic device, the trigger event representing an expiration of a timer that elapses while the electronic device is connected to an external power supply and the electronic device is in a first charge mode where the battery is permitted to be charged to a maximum charge capacity; and transitioning from the first charge mode to a second charge mode which represents the battery protection mode, the battery protection mode having a reduced maximum permitted charge level for the battery as compared to the first charge mode.

In addition to any of the above described methods, any one or combination of: further including, prior to said detecting the trigger event: determining that the electronic device is disconnected from the external power supply and that a charge level of the battery is above a threshold charge level; holding the timer while the electronic device is disconnected from the external power supply and the charge level of the battery is above the threshold charge level; further including, prior to said detecting the trigger event: determining that the electronic device is disconnected from the external power supply and that a charge level of the battery is above a threshold charge level; holding the timer while the electronic device is disconnected from the external power supply and the charge level of the battery is above the threshold charge level; ascertaining that the electronic device is reconnected to the external power supply; and resuming the timer in response to the electronic device being reconnected to the external power supply; further including: presenting a prompt indicating that a transition from the first charge mode to the second charge mode will occur; receiving user input to the prompt; and transitioning from the first charge mode to the second charge mode in response to said receiving user input to the prompt; wherein in the second charge mode the charge level of the battery is below a maximum charge capacity of the battery, and wherein the method further includes: adjusting an indication of battery charge level for the battery based on the battery protection mode to indicate that the battery is at the maximum charge capacity while the battery is charged below the maximum charge capacity.

A computer-implemented method for transitioning between batter charge modes, the method including: operating in a first charge mode where an electronic device is connected to an external power supply and a battery of the electronic device is permitted to be charged to a maximum charge capacity; running a timer that elapses while the electronic device is in the first charge mode; transitioning, responsive to expiration of the timer, from the first charge mode to a second charge mode which represents a battery protection mode in which a maximum permitted battery charge level of the battery is reduced from the first charge mode; ascertaining that a charge level of the battery falls below a threshold charge level; and transitioning from the second charge mode to the first charge mode in response to said ascertaining that the charge level of the battery falls below the threshold charge level.

In addition to any of the above described methods, any one or combination of: further including, prior to said transitioning from the first charge mode to the second charge mode: holding the timer while the electronic device is disconnected from the external power supply and the charge level of the battery is above a different threshold charge level; ascertaining that the electronic device is reconnected to the external power supply; and resuming the timer in response to the electronic device being reconnected to the external power supply; further including, prior to said transitioning from the first charge mode to the second charge mode: holding the timer while the electronic device is disconnected from the external power supply and the charge level of the battery is above a different threshold charge level; ascertaining that the battery falls below the different threshold charge level; and resetting the timer in response to ascertaining that the battery falls below the different threshold charge level; further including, responsive to expiration of the timer, presenting a prompt indicating that a transition to the battery protection mode will occur; further including adjusting an indication of battery charge level for the battery based on the battery protection mode to indicate that the battery is at the maximum charge capacity while the battery is charged below the maximum charge capacity in the battery protection mode.

Techniques for battery protection mode are described. Although implementations are described in language specific to structural features and/or methodological acts, it is to be understood that the implementations defined in the appended claims are not necessarily limited to the specific features or acts described. Rather, the specific features and acts are disclosed as example forms of implementing the claimed implementations.

What is claimed is:

1. A system comprising:
at least one processor; and
one or more computer-readable storage media including instructions stored thereon that, responsive to execution by the at least one processor, cause the system perform operations including:
detecting a trigger event associated with a battery protection mode for a battery of an electronic device, the trigger event representing one or more of an expiration of a timer or information received from a fuel gauge that monitors state of the battery; and
transitioning from a first charge mode to a second charge mode which represents the battery protection mode, the battery protection mode having a reduced maximum permitted charge level for the battery as compared to the first charge mode.

2. A system as recited in claim 1, wherein the timer is configured to elapse in response to the electronic device being connected to an external power supply and the electronic device being in the first charge mode.

3. A system as recited in claim 1, wherein the timer is configured to elapse in response to the electronic device being connected to an external power supply and the electronic device being in the first charge mode, and wherein the operations further include, prior to said detecting the trigger event:
determining that the electronic device is disconnected from the external power supply and that a charge level of the battery is above a threshold charge level;
holding the timer while the electronic device is disconnected from the external power supply and the charge level of the battery is above the threshold charge level.

4. A system as recited in claim 1, wherein the timer is configured to elapse in response to the electronic device being connected to an external power supply and the electronic device being in the first charge mode, and wherein the operations further include, prior to said detecting the trigger event:
determining that the electronic device is disconnected from the external power supply and that a charge level of the battery is above a threshold charge level;
holding the timer while the electronic device is disconnected from the external power supply and the charge level of the battery is above the threshold charge level;
ascertaining that the electronic device is reconnected to the external power supply; and
resuming the timer in response to the electronic device being reconnected to the external power supply.

5. A system as recited in claim 1, wherein the information received from the fuel gauge comprises one or more of an indication that a remaining full charge capacity of the battery drops below a threshold charge value, an indication that a cell balancing time for the battery exceeds a threshold cell balancing time, or an indication that a time at which the battery has spent at full charge exceeds a full charge threshold time.

6. A system as recited in claim 1, wherein said transitioning from the first charge mode to the second charge mode occurs automatically in response to the trigger event and independent of user input.

7. A system as recited in claim 1, wherein the operations further include presenting a prompt indicating that a transition from the first charge mode to the second charge mode will occur, the prompt including a first selectable control which is selectable to permit the transition to the second charge mode, and a second selectable control which is selectable to prevent the transition to the second charge mode.

8. A system as recited in claim 1, wherein in the second charge mode the charge level of the battery is below a maximum charge capacity of the battery, and wherein the operations further include:
adjusting an indication of battery charge level for the battery based on the battery protection mode to indicate that the battery is at the maximum charge capacity while the battery is charged below the maximum charge capacity

9. A system as recited in claim 1, wherein in the second charge mode the charge level of the battery is below a maximum charge capacity of the battery, and wherein the operations further include:
adjusting an indication of battery charge level for the battery based on the battery protection mode to indicate that the battery is at the maximum charge capacity while the battery is charged below the maximum charge capacity;
ascertaining that the electronic device is transitioned from the second charge mode to the first charge mode; and
outputting the indication of battery charge level to correspond to an actual estimated charge level of the battery.

10. A system as recited in claim 1, wherein the operations further include:
ascertaining that a battery charge level of the battery falls below a threshold charge level while the electronic device is in the second charge mode; and
transitioning from the second charge mode to the first charge mode in response to said ascertaining that the battery charge level falls below the threshold charge level, the first charge mode having a higher permitted maximum charge level as compared to the second charge mode.

11. A computer-implemented method, comprising:
detecting a trigger event associated with a battery protection mode for a battery of an electronic device, the trigger event representing an expiration of a timer that elapses while the electronic device is connected to an external power supply and the electronic device is in a first charge mode where the battery is permitted to be charged to a maximum charge capacity; and
transitioning from the first charge mode to a second charge mode which represents the battery protection mode, the battery protection mode having a reduced maximum permitted charge level for the battery as compared to the first charge mode.

12. A method as described in claim 11, further comprising, prior to said detecting the trigger event:
determining that the electronic device is disconnected from the external power supply and that a charge level of the battery is above a threshold charge level;
holding the timer while the electronic device is disconnected from the external power supply and the charge level of the battery is above the threshold charge level.

13. A method as described in claim 11, further comprising, prior to said detecting the trigger event:
determining that the electronic device is disconnected from the external power supply and that a charge level of the battery is above a threshold charge level;
holding the timer while the electronic device is disconnected from the external power supply and the charge level of the battery is above the threshold charge level;
ascertaining that the electronic device is reconnected to the external power supply; and
resuming the timer in response to the electronic device being reconnected to the external power supply.

14. A method as described in claim 11, further comprising:
presenting a prompt indicating that a transition from the first charge mode to the second charge mode will occur;
receiving user input to the prompt; and
transitioning from the first charge mode to the second charge mode in response to said receiving user input to the prompt.

15. A method as described in claim 11, wherein in the second charge mode the charge level of the battery is below a maximum charge capacity of the battery, and wherein the method further comprises:
adjusting an indication of battery charge level for the battery based on the battery protection mode to indicate that the battery is at the maximum charge capacity while the battery is charged below the maximum charge capacity.

16. A computer-implemented method, comprising:
operating in a first charge mode where an electronic device is connected to an external power supply and a battery of the electronic device is permitted to be charged to a maximum charge capacity;
running a timer that elapses while the electronic device is in the first charge mode;
transitioning, responsive to expiration of the timer, from the first charge mode to a second charge mode which represents a battery protection mode in which a maximum permitted battery charge level of the battery is reduced from the first charge mode;
ascertaining that a charge level of the battery falls below a threshold charge level; and
transitioning from the second charge mode to the first charge mode in response to said ascertaining that the charge level of the battery falls below the threshold charge level.

17. A method as described in claim 16, further comprising, prior to said transitioning from the first charge mode to the second charge mode:
holding the timer while the electronic device is disconnected from the external power supply and the charge level of the battery is above a different threshold charge level;
ascertaining that the electronic device is reconnected to the external power supply; and
resuming the timer in response to the electronic device being reconnected to the external power supply.

18. A method as described in claim 16, further comprising, prior to said transitioning from the first charge mode to the second charge mode:
holding the timer while the electronic device is disconnected from the external power supply and the charge level of the battery is above a different threshold charge level;
ascertaining that the battery falls below the different threshold charge level; and
resetting the timer in response to ascertaining that the battery falls below the different threshold charge level.

19. A method as described in claim 16, further comprising, responsive to expiration of the timer, presenting a prompt indicating that a transition to the battery protection mode will occur.

20. A method as described in claim 16, further comprising adjusting an indication of battery charge level for the battery based on the battery protection mode to indicate that the battery is at the maximum charge capacity while the battery is charged below the maximum charge capacity in the battery protection mode.
